(19) United States
(12) Patent Application Publication
(10) Pub. No.: US 2016/0129570 A1
(43) Pub. Date: May 12, 2016

(54) MOTOR VEHICLE GAS CAP REMOVAL DEVICE

(71) Applicant: EAGLE ONE INNOVATIONS, INC., Green Bay, WI (US)

(72) Inventor: Steve Marchiando, Glenbeulah, WI (US)

(21) Appl. No.: 14/934,430

(22) Filed: Nov. 6, 2015

Related U.S. Application Data
(60) Provisional application No. 62/075,969, filed on Nov. 6, 2014.

(51) Int. Cl. B25B 27/00; B67B 7/18

(52) U.S. Cl. CPC B25B 27/0042; B67B 7/18

(57) ABSTRACT

A gas tank cap removal and reattachment device is configured to clears all gas tank access panel doors and works with all gas caps. The device is configured such that the tether attached to the gas cap cannot be trapped within the device or interfere with use of the device. The device is preferably monolithic in structure and generally comprises a main support member comprising an upper portion and a lower portion; an upper handle portion disposed at the upper portion of the main support member; and a gas cap gripping portion disposed at the lower portion of the main support member wherein a user can grasp the upper handle portion by hand to exert torque on the gas cap gripping portion when the device is engaged with the gas cap.

This application claims the benefit and priority of U.S. Provisional Patent Application No. 62/075,969 filed Nov. 6, 2014.

### FIELD OF THE INVENTION

This invention relates generally to devices that are used to assist users in twisting items for the purpose of removal and attachment. More particularly, it relates to a device that is used to assist a user in the process of removing a motor vehicle gas cap from the gas tank inlet port and also to assist in reattaching the gas cap as desired or required. It also relates to such a device that is easy to use, is monolithic in construction and light weight in construction.

### BACKGROUND OF THE INVENTION

Modern gasoline service stations typically require motor vehicle operators to fill the gas tanks of their own motor vehicles. For some, this is not an easy task. Access to the gas tank is made available by means of a gas cap that is screwed on to a gas tank inlet port or a gas tank filler neck. Furthermore, the gas cap is generally recessed behind an access panel door that opens on the rear panel or one of the rear quarter panels of the vehicle to help prevent loss of the gas cap. The typical gas cap has a cylindrical top surface from which extends a small torqueing protrusion. For anyone with weak wrists or forearms, properly grasping, removing and properly retightening the gas cap using this torqueing protrusion can be difficult. Further, proper sealing of evaporative fumes to minimize pollution has led most automotive manufacturers to design gas tank caps that include a feature that ensures proper tightening of the cap. That is, the user must rotate the gas cap until it emits an audible “click” which indicates to the user that the gas cap is fully attached to the filler neck. Lastly, most motor vehicles have a tether that connects the gas cap to the vehicle which is intended to prevent inadvertent loss of the gas cap. One end of this tether is attached to a torqueing protrusion on the gas cap and the other end is anchored to the access door or to another structure in the area of the access door.

Due to the difficulty in removing gas tank caps, prior art has developed a number of wrench-like devices to facilitate the removal of the gas tank cap. However, on shortcoming in the prior art is that the tether of the gas cap can interfere with proper operation of the device. Another shortcoming is that prior art devices tend to be fabricated of a number of elements, which makes them more expensive and difficult to fabricate. Lastly, not all devices are configured to clear all gas tank cap access panel doors. Accordingly, it is a goal of the present invention to provide a gas tank cap removal and reattachment device that is easy to use, easy to fabricate, is monolithic in construction, clears all gas tank access panel doors and works with all gas caps, and is configured such that the tether which is attached to the gas cap cannot be trapped within the device or interfere with use of the device.

### SUMMARY OF THE INVENTION

In view of the foregoing, the present invention provide a gas tank cap removal and reattachment device that is easy to use, easy to fabricate, is monolithic in construction, clears all gas tank access panel doors and works with all gas caps, and is configured such that the tether which is attached to the gas cap cannot be trapped within the device or interfere with use of the device.

The foregoing and other features of the present invention will be apparent from the detailed description that follows.

### BRIEF DESCRIPTION OF THE DRAWINGS

FIG. 1 is a side elevational view of a preferred embodiment of the gas tank cap removal and reattachment device that is constructed in accordance with the present invention.

FIG. 2 is a side elevational view of the gas tank cap removal and reattachment device shown in FIG. 1 and showing the opposite side of the device.

FIG. 3 is an enlarged view of the bottom portion of the device shown in FIGS. 1 and 2.

FIG. 4 is a perspective view of a gas tank cap of the type with which the present invention would be used.

### DETAILED DESCRIPTION

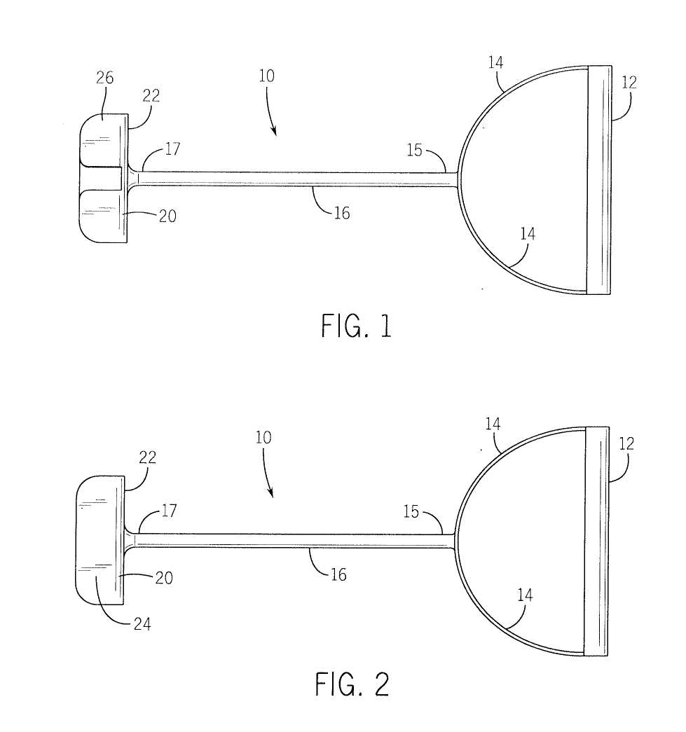

Referring now to the drawings in detail wherein like numbers represent like elements throughout, FIG. 1 illustrates a first plan view of a preferred embodiment of the gas tank cap removal and reattachment device, generally identified 10. It is preferable that the device 10 of the present invention be molded as a single piece of plastic material. The device 10 comprises an upper handle portion 12. The upper handle portion 12 includes opposing support members 14 that terminate at the upper portion 15 of a main support member 16. In the preferred embodiment, the support member 16 is a main support rod. The upper handle portion 12 is generally perpendicular to the main support rod 16 and is provided to allow the user to grasp the gas tank cap removal and reattachment device 10 with one hand. The lower portion 17 of the main support rod 16 terminates in a gas cap gripping portion 20.

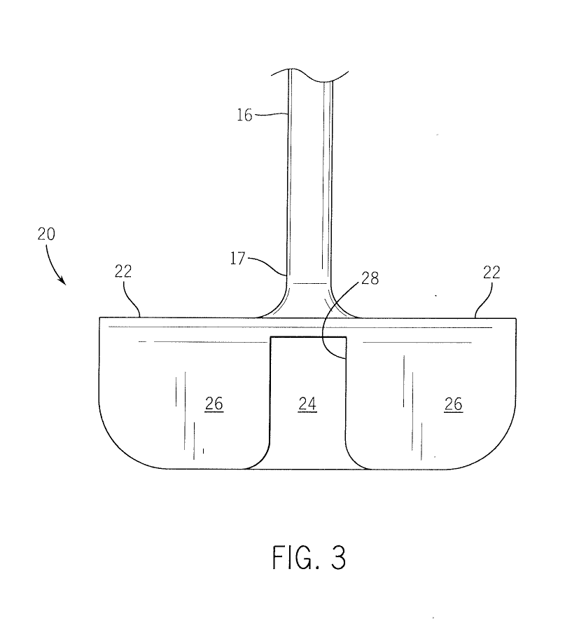

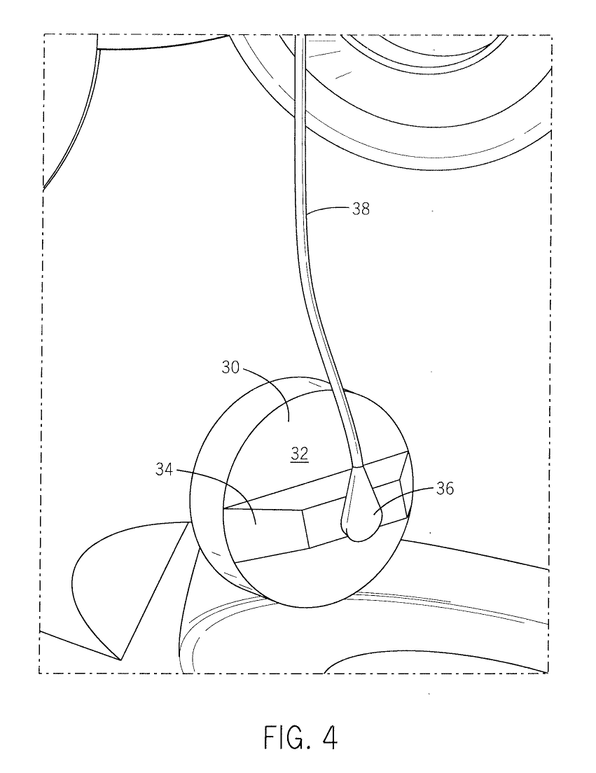

The gas cap gripping portion 20 is a substantially inverted U-shaped structure. See FIG. 3. The gas cap gripping portion 20 having an upper support portion 22 and two downwardly extending side portions 24, 26. The upper support portion 22 is disposed substantially perpendicularly relative to the main support rod 16. The first downwardly extending side portion 24 is substantially continuous, as is shown in FIG. 2. The second downwardly extending side portion 26 is discontinuous and further comprises a gap 28, as is shown in FIGS. 2 and 3. The presence of the gap 28 allows the gas cap gripping portion 20 to be position atop a gas cap 30 of conventional manufacture without interfering with a tether 38 that is connected to the cap 30. See FIG. 4.

In application, the gas cap 30 comprises a top surface 32 and a torqueing protrusion 34 extending upwardly from the top surface 32. The torqueing protrusion 34 is that part of the cap 30 that would provide the user with the ability to torque the cap 30 to unscrew it and remove it, or to reposition it and turn it to reattach the cap 30. One end 36 of a tether 38 is attached to the torqueing protrusion 34 as alluded to above. Assuming that the gas cap 30 is attached, the user would take the device 10 and position the gas cap gripping portion 20 of the device 10 atop a gas cap 30 of conventional manufacture. In such instance, it would be necessary for the user to position the second downwardly extending side portion 26 and gap 28 to that side of the torqueing protrusion 34 where the tether 38 extends away from the torqueing protrusion 34. The user can then apply torque by hand to the device 10 to loosen and remove or to tighten the gas cap 30.

Based on the foregoing, it will be seen that there has been provided a new and useful gas tank cap removal and reattachment device 10 that is easy to use, easy to fabricate, is monolithic in construction, clears all gas tank access panel doors and works with all gas caps, and is configured such that the tether which is attached to the gas cap 30 cannot be trapped within the device or interfere with use of the device. Lastly, it is preferable that the device 10 of the present invention be molded as a single piece of plastic material.

The details of the invention having been disclosed in accordance with the foregoing, I claim:

1. A gas tank cap removal and reattachment device comprising:
a main support member comprising an upper portion and a lower portion;
an upper handle portion disposed at the upper portion of the main support member; and
a gas cap gripping portion disposed at the lower portion of the main support member;
wherein a user can grasp the upper handle portion by hand to exert torque on the gas cap gripping portion when the device is engaged with a gas cap.

2. The gas tank cap removal and reattachment device of claim 1 wherein the main support member is a rod.

3. The gas tank cap removal and reattachment device of claim 1 wherein the upper handle portion is disposed perpendicularly to the main support member and further comprises opposing support members that terminate at the upper portion of the main support member.

4. The gas tank cap removal and reattachment device of claim 1 wherein the gas cap gripping portion comprises an upper support portion and two downwardly extending side portions, the upper support portion and the side portions being integrally formed.

5. The gas tank cap removal and reattachment device of claim 4 wherein one of the side portions of the gas cap gripping portion comprises a gap, wherein the gap cap gripping portion is positioned atop a torqueing protrusion of a gas cap and a tether to the torqueing protrusion is disposed within the gap.

6. The gas tank cap removal and reattachment device of claim 1 wherein the gas cap gripping portion is substantially perpendicular to the io main support member.

7. The gas tank cap removal and reattachment device of claim 1 wherein the device is formed of a single piece of plastic material.

8. A gas tank cap removal and reattachment device for use with a gas cap of a motor vehicle, the gas cap comprising a torqueing protrusion and a tether to the torqueing protrusion, the device comprising:
a main support member comprising an upper portion and a lower portion;
an upper handle portion disposed at the upper portion of the main support member; and
a gas cap gripping portion disposed at the lower portion of the main support member;
wherein a user can grasp the upper handle portion by hand to exert torque on the gas cap gripping portion when the device is engaged with the gas cap.

9. The gas tank cap removal and reattachment device of claim 8 wherein the main support member is a rod.

10. The gas tank cap removal and reattachment device of claim 8 wherein the upper handle portion is disposed perpendicularly to the main support member and further comprises opposing support members that terminate at the upper portion of the main support member.

11. The gas tank cap removal and reattachment device of claim 8 wherein the gas cap gripping portion comprises an upper support portion and two downwardly extending side portions, the upper support portion and the side portions being integrally formed.

12. The gas tank cap removal and reattachment device of claim 8 wherein one of the side portions of the gas cap gripping portion comprises a gap, wherein the gap cap gripping portion is positioned atop the torqueing protrusion of the gas cap and the tether to the torqueing protrusion is disposed within the gap of the one side portion.

13. The gas tank cap removal and reattachment device of claim 8 wherein the gas cap gripping portion is substantially perpendicular to the main support member.

14. The gas tank cap removal and reattachment device of claim 8 wherein the device is formed of a single piece of plastic material.
